(19) United States
(12) Patent Application Publication
(10) Pub. No.: US 2006/0064840 A1
(43) Pub. Date: Mar. 30, 2006

(54) Automotive wiper

(76) Inventor: Se-Heon Park, Seongnam-si (KR)

Correspondence Address: MAYER, BROWN, ROWE & MAW LLP, 1909 K STREET, N.W., WASHINGTON, DC, 20006, US

(21) Appl. No.: 11/229,593

(22) Filed: Sep. 20, 2005

(30) Foreign Application Priority Data
Sep. 30, 2004 (KR) 2004-0077635
Nov. 6, 2004 (KR) 2004-0093340

(51) Int. Cl. B60S 1/38

(52) U.S. Cl. 15/250.43; 15/250.451; 15/250.32

(57) ABSTRACT

Provided is an automotive wiper that has a frame, which supports a rubber blade, is formed in one piece with a tension spring, and is easily assembled with the blade. A tensile member (40) symmetrically extends in one piece from a center of the wiper in opposite directions to form both a single-piece tension spring and skeletal frame. A slot (41) is centrally cut along a length of the tensile member to insert the blade (30) therein. A blade mounting receptacle (42) is formed at a center of the slot to insert the blade for its assembly. A guiding member (43) is formed above the mounting receptacle. An assembly guide (43a) is formed on the guiding member to center the blade for assembly. A coupling positioner (30a) is centrally disposed on a surface of the blade to position the blade for assembly with respect to the assembly guide formed on the guiding member.

### BACKGROUND OF THE INVENTION

1. Field of the Invention

The present invention relates to an automotive wiper, and more particularly, to an automotive wiper that forms a frame holding a rubber blade of the wiper and a tension spring for maintaining tension on the rubber blade in one piece and which has a structure that allows easy installation and removal of the rubber blade on and from the wiper frame.

2. Description of the Related Art

An automotive wiper is operated by a wiper motor through a mechanical linkage that moves the wiper arm back and forth in a predetermined arc. Disposed on the end of the wiper arm is a detachably mounted wiper frame to which a wiper blade made of rubber is attached.

Conventional wipers attached to wiper arms include a skeletal frame and a blade portion mounted on the frame and contacting a windshield to wipe it in a pendular movement, as shown in FIGS. 1 through 3.

A conventional wiper includes: a main frame 12 having an adapter 11 thereon for mounting a wiper arm 10; a first frame 16 symmetrically mounted on rivet joints 13 at either end of the main frame 12, and having a blade bracket 15 for evenly distributing load on the blade 14 and holding the blade 14 inserted therein; a second frame 17 symmetrically mounted on rivet joints 13 at either end of the first frame 16, and having blade brackets 15 on either end thereof for evenly distributing load on the blade 14 and holding the blade 14 inserted therein; a blade 14 having a rail portion 19 formed thereon along which resilient tension springs 18 and 18a having a predetermined elasticity are inserted, the resilient tension springs applying a predetermined load furnished by the first and second frames 16 and 17 along the length of the blade 14 so that the blade 14 presses evenly against a windshield when wiping it; and a metallic tension springs 18 and 18a inserted along the length on either side of the blade 14 to support the load furnished by the first and second frames 16 and 17.

Here, in order for the main frame 12 to transmit the movement of the wiper arm 10 to an arcuate movement of the blade 14, the wiper 10, blade 14, and the tension springs 18 and 18a that provide resilience to the blade 14 converge at one point so that they move in unison according to the movement of the wiper 10. Also, the first and second frames 16 and 17 evenly distribute load furnished by the main frame 12, and, along with the main frame 12, are press-formed to have holes formed therein to facilitate water drainage and reduce weight.

The blade has a groove 20 running lengthwise therealong for guiding the blade brackets 15 of the first and second frames 16 and 17, and a separate rail portion 19 for accommodating the tension springs 18 and 18a that provide resilience to the blade 14.

In the structure of this type of wiper, because the main frame 12 and the first and second frames 16 and 17 are formed separately from sheet metal and assembled together with the blade 14 and the tension springs 18 and 18a, in snowy and icy conditions of winter, the connecting and coupling portions of the unit can be hampered by frozen precipitation and thus not function properly. Accordingly, blade tension or other properties of the wiper can be affected so that the wiper is unable to aptly fulfill its wiping role.

Also, because the load on the blade is applied at certain points on the blade, it is unevenly distributed along the length of the blade. This unevenness causes premature wear of blade areas that are more compressed, while less compressed areas are prone to streak or overshoot the windshield glass underneath.

The wiper shown in FIGS. 4 and 5 does not have a main frame supporting a metal frame separately from a blade, but has tension springs inserted in the blade 14, over which a rubber cover 21 covers the unit.

That is, the rail portion 19 is formed along the lengths on either side of the blade 14, tension springs 18 and 18a are inserted into each rail portion, and a rubber cover 21 that functions as a spoiler is then inserted over the unit to conceal the tension springs 18 and 18a.

The problem with the foresaid wiper is that the aggregate tension of the two tension springs 18 and 18a and the rubber cover 21 necessitate the wiper arm maintaining an increased load on the wiper for the wiper to be operationally effective, unduly stressing the mechanism.

Another problem of using two tension springs 18 and 18a disposed on either side of the blade 14 is that the process of welding or otherwise fixing the central and end portions to the blade and the structure thereof is cumbersome and complex.

Additionally, the method of using a rubber cover 21 to partially wrap the blade 14 and secure the two tension springs separately inserted into the blade has the shortcoming in that special manufacturing technology and an expensive rubber with a customized elasticity for the cover 21 must be used in order to appropriately wrap and seal the blade 14.

Furthermore, with the method of using a rubber cover 21 to complete the assembly of the wiper, additional elements cannot be attached thereafter. Deformation of the two metal tension springs 18 and 18a can occur while they are being welded together at their central and end portions or during their use in the wiper blade. In this case, their tensility can be considerably altered, leading to a change in the shape of the wiper itself.

Furthermore, the two tension springs 18 and 18a must undergo an involved manufacturing and assembly process, including roll forming, welding, etc., reducing their manufacturing efficiency.

Moreover, during the process of inserting the two tension springs 18 and 18a in the blade 14 or preparing portions thereof for assembly, their coatings can be scraped off, reducing their ability to resist corrosion and their structural integrity.

When the tension springs 18 and 18a have been assembled and the rubber cover 21 has been drawn over the wiper, the blade 14 cannot be installed or removed, negating the possibility of using blade refills.

Although the wiper using the rubber cover improves on a conventional wiper by using less parts, the structure is still complex due to the use of the two tension springs 18 and 18a, the rubber cover 21, etc., elevating the product's unit price and making it difficult to change the design.

Finally, because the wiper is assembled with the blade 14 fixed in position, the desired even distribution of load across the blade 14 on the windshield is difficult to achieve, resulting in noise caused by judder or overshooting of the glass during wiper operation while driving.

### SUMMARY OF THE INVENTION

The present invention is designed to solve the problems of the prior art, and therefore an object of the invention is to provide an automotive wiper capable of forming the skeletal frame and tension spring thereof in one piece in a single metal forming stage and assembling the single piece with a rubber blade by inserting the latter therein.

Another object of the invention is to provide an automotive wiper capable of being interchanged with or replacing existing automotive wipers having wiper arms with comparatively weak, versus strong, springs.

A further object of the invention is to provide an automotive wiper capable of forming a tension spring and skeletal frame of an automotive wiper from a single metal sheet and fitting it with a blade, in order to retain structural strength, negating the need for separate fitting or welding and providing ease of assembly, high manufacturability, and a simple structure.

A still further object of the invention is to provide an automotive wiper capable of remaining in contact with a windshield at high speeds to prevent deformation of the tension spring or other damage to the wiper, so the wiper retains its tensility for even distribution of load across the blade and reliable operation.

A yet further object of the invention is to provide an automotive wiper that is strengthened overall through minimizing the number of parts needed in order to prevent deformation or deviations in material strength. Also, quality control in assembly and manufacturing is improved due to the simpler manufacturing processes achieved by using less parts and bendable metal. The latter also contributes to a reduction in manufacturing cost and unit price.

An additional object of the invention is to provide a one-piece frame and tension spring allowing easy removal and attachment of blades so that refill blades can be used for an extended life of the wiper.

Another object of the invention is to provide an automotive wiper capable of being manufactured in a variety of designs by slightly altering the one-piece frame and tension spring. Thus, the overall design of the wiper can be varied.

Yet another object of the invention is to provide an automotive wiper capable of being manufactured in a single mold to change the surface form of the one-piece frame and tension spring of the wiper, in order to achieve desired distribution of load on the blade and a variety of designs.

Still another object of the invention is to provide an automotive wiper capable of increased wiping ability and attachment to a windshield to prevent noise induced by judder or overshooting when driving, by forming the frame and tension spring in a single piece for maintaining an even distribution of load along the wiper blade on a windshield.

Another object of the invention is to provide an automotive wiper with a frame and a tension spring formed in one piece that allows a blade to be easily installed on a single rail thereon.

In order to accomplish the above objects, the present invention provides an automotive wiper having a frame supporting a blade that closely contacts a surface of an automotive windshield and is attached to a wiper arm for pressing and operating the wiper against and across the windshield via an adapter, and a tension spring with a predetermined tension inserted along insertion grooves of the blade for evenly distributing load along the blade onto the windshield. Improvements of the present invention include: a tensile member symmetrically extending in one piece from a center in opposite directions forming both a single-piece tension spring and skeletal frame that attaches to the wiper arm; a slot centrally cut along a length of the tensile member for inserting the insertion grooves of the blade therein; a blade mounting receptacle formed at a center of the slot for inserting the blade for assembly of the blade; a guiding member formed above the mounting receptacle for guiding the top portion of the blade that the slot inserts along and for supporting and positioning the blade; an assembly guide formed on the guiding member for centering the blade for assembly; and a coupling positioner centrally disposed on a surface of the blade for positioning the blade for assembly with respect to the assembly guide formed on the guiding member.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view of a conventional automotive wiper;

FIG. 2 is an exploded perspective view showing the assembly of the tension springs of a conventional wiper blade;

FIG. 3 is a sectional view showing the assembly of the tension springs of a conventional wiper blade;

FIG. 4 is a perspective view of another type of conventional automotive wiper;

FIG. 5 is a sectional view of the automotive wiper of FIG. 4;

FIG. 6 is a perspective view of an automotive wiper according to a preferred embodiment of the present invention;

FIG. 7 is a side view of the automotive wiper of FIG. 6;

FIG. 8a is a frontal view of the automotive wiper of FIG. 6;

FIG. 8b is a top view of the automotive wiper of FIG. 6;

FIG. 8c is a bottom view of the automotive wiper of FIG. 6;

FIG. 9 is an exploded perspective view showing a portion of the automotive wiper according to the present invention;

FIG. 10 is a sectional view showing the assembly of the tensile member and the blade of an automotive wiper according to a preferred embodiment of the present invention; and

FIG. 11 is a sectional view showing the structure of a blade holder formed on the tensile member of an automotive wiper according to a preferred embodiment of the present invention.

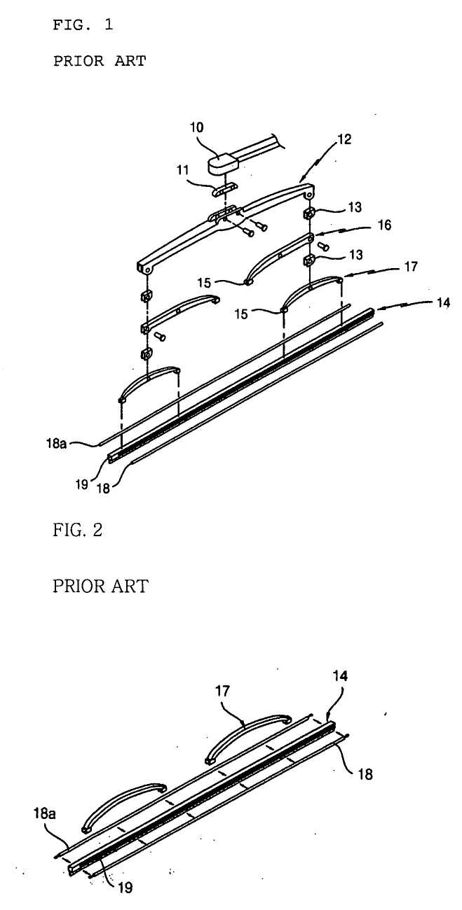

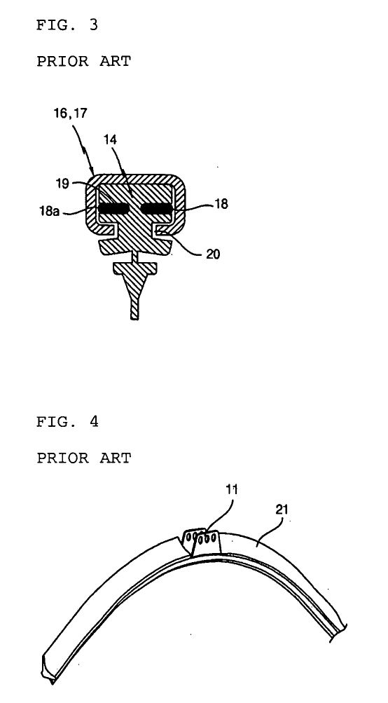

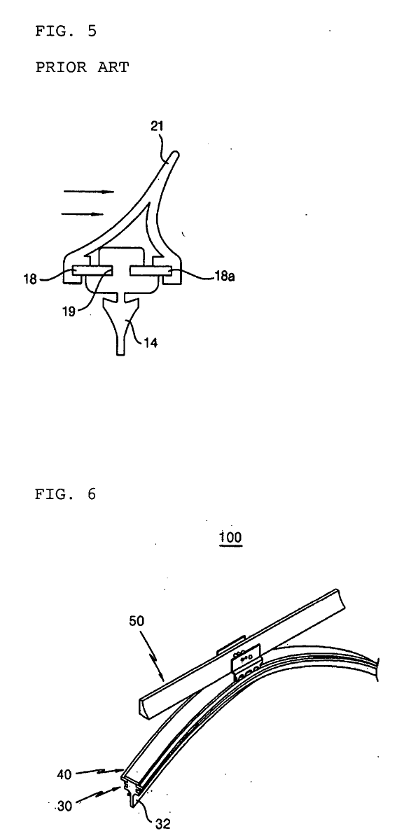

### DETAILED DESCRIPTION OF THE INVENTION

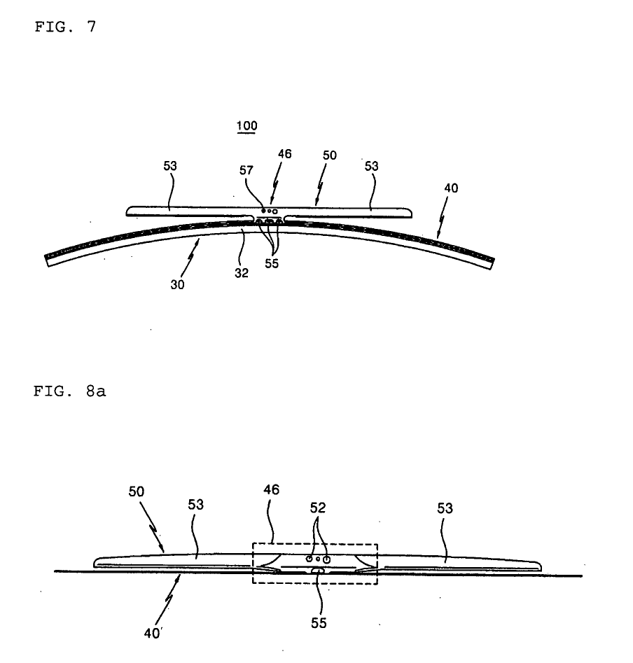

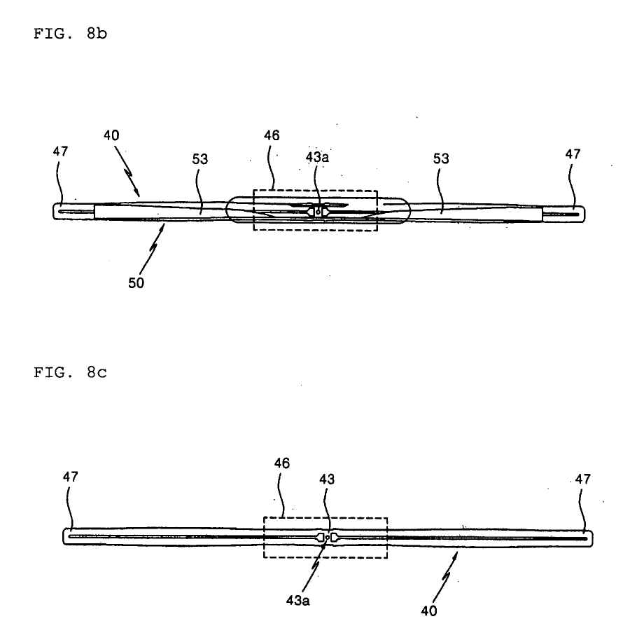

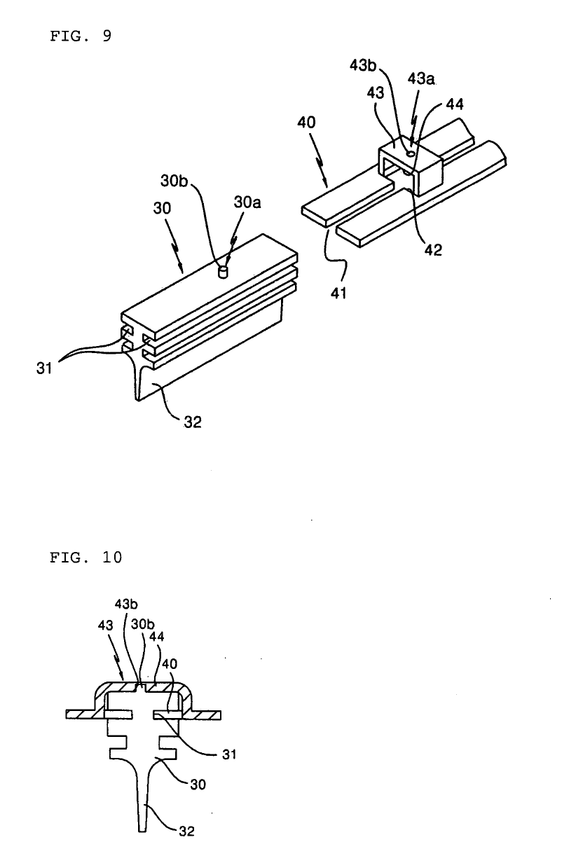

Hereinafter, a preferred embodiment of the present invention will be described in detail with reference to FIGS. 6 through 11, which show embodiments of the present invention.

A press-formed tensile member 40 having a predetermined tensility is constituted in a single piece that extends symmetrically outward from a central portion thereof, and functions as both a lone tension spring and skeletal frame that attaches to a wiper arm.

A slot 41 is cut in a longitudinal direction along the central portion of the tensile member 40 in order to insert the portion of the blade 30 between the insertion grooves 31 formed on either side of the blade 30. A mounting groove 42 is centrally formed at a central portion in an appropriate location on the slot 41. A guiding member is provided at the top of the mounting receptacle 42 for guiding the top portion of the blade 30 when it is inserted and aligned along the slot 41 to support and fix the blade 30.

Also, an assembly guide 43a is formed on the guiding member 43 for centering the blade 30 for assembly, and a coupling positioner 30a is disposed on a central surface of the blade 30 for matching the assembly position of the blade with the assembly guide 43a.

The assembly guide 43a may include a centering hole 43b that centers the rubber blade 30 at the guiding member 43 for stationing it, and the coupling positioner 30a may include a centering knob 30b formed at the central portion of the blade 30 for inserting into the centering hole 43b of the guiding member 43.

Also, the mounting receptacle 42 formed on the tensile member 40 may be formed at the central portion of the slot 41.

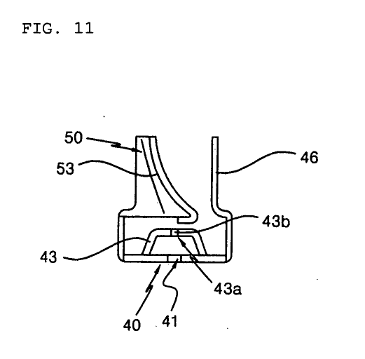

Furthermore, the guiding member 43 formed on the tensile member 40, as shown in FIG. 11, may be formed as a housing arch 44 that can entirely cover a portion of the blade 30. This structure can use variations of bent holders, a number of different protruding members, or holders in a wide range of shapes.

An adapter 46 for attaching to the wiper arm may be formed in one piece with the tensile member 40 at the center thereof, and a spoiler 40 may be formed in one piece with the tensile member 40 at a top portion thereof.

The spoiler 50 includes an adapter 46 having centrally disposed connecting holes 52 for attaching to the wiper arm, wings 53, extending symmetrically outward from the adapter 46 in opposite directions, the wings 53 intended for stabilizing airflow and reducing drag by having a curved leading edge and a plurality of airflow holes 57 formed therein.

Referring to FIGS. 6 through 10, the spoiler 50 is formed not in one piece with the tensile member 40, but in a separate piece attached to the center of the tensile member 40 via an adapter 46, and has a plurality of spring clips formed at the bottom thereof for detachably mounting to the tensile member 40.

A detailed description of the function and ability of the above wiper 100 will now be given with reference to FIGS. 6 through 11.

The wiper 100 of the present invention includes a frame supporting a blade 30 that closely contacts a surface of an automotive windshield and is attached to a wiper arm for pressing and operating the wiper 100 against and across the windshield via an adapter, and a tensile member 40 integrating a tension spring with a predetermined tension inserted along a rail portion of the blade for evenly distributing load along the blade onto the windshield and a press-formed metal frame of a conventional wiper. The tensile member 40 functions in two capacities—one for attaching to the wiper arm and the other for attaching to the wiper blade 30, and can be press-formed from sheet metal and be formed with a predetermined bend in order to give the blade 30a degree of tensility so that the latter presses against a windshield when mounted thereon.

When the blade 30 is pressed against the windshield, the wiper arm exerts a load on the tensile member 40, which in turn applies the load evenly along the wiper blade 30 on the surface of the windshield. The effect is the same as a conventional wiper using multiple parts to press the blade 30 against the windshield.

The difference in the wiper of the present invention is that the portion operated by the wiper arm and the portion pressing the blade 30 against the windshield are on a common tensile member 40.

In order to enable installation and removal of the tensile member 40 to and from the wiper arm, an adapter 46 is formed on the tensile member 40 or a separate adapter 46 is attached thereto. The adapter 46 facilitates installation of the tensile member 40 to the wiper arm. In the case of the adapter 46 that attaches to the wiper arm being formed in one piece at the center of the tensile member 40, a spoiler 50 may also be formed in the same piece as the tensile member 40 at a central portion thereof.

In order to install the blade 30 along the tensile member 40 in a direction toward the surface of the windshield, a slot 41 is centrally cut along the length of the tensile member 40, whereupon the edge 32 of the blade 30 protrudes from the slot 41 and the blade 30 is laterally fixed and balanced by insertion grooves 31 formed on either side thereof that the inner edges of the tensile member 40 defined by the slot 41 insert into.

The tensile member 40 is easily press formed in a single piece from a metal plate of a predetermined thickness, having a slot 41 cut centrally along its length and a connecting portion 47 on either end of the slot 41 for connecting the tensile member 40 on either sides of the slot 41. The tensile member 40 has an equal tensility on both sides for evenly distributing load along a wiper blade 30 held in the slot 41.

The blade 30 protrudes against the windshield from along the length of the slot 41; and the other side of the blade 30 is supported by the mounting receptacle 42 and guiding member 43 on the tensile member 40.

The mounting receptacle 42 is disposed at the central portion of the slot 41 formed along the length of the tensile member 40, and either end of the tensile member 40 extending from its central portion evenly distributes load.

The mounting receptacle 42 includes the guiding member 43 for inserting the blade 30 lengthwise. The guiding member 43 may be formed as a housing arch 44 that completely covers the central portion of the blade, as shown in FIG. 11.

The guiding member 43 may have an assembly guide 43a formed thereon for centering the blade 30 for assembly. A coupling positioner 30a may be centrally disposed on the surface of the blade 30 for corresponding to the assembly guide 43a formed on the guiding member 43 and allowing easy assembly of the blade 30.

The blade 30 can easily be assembled by inserting it into the slot 41 and pulling from either side. Because the blade 30 cannot be precisely positioned by inserting it through the guiding member 43 to either side, the assembly guide 43a is formed on the guiding member 43 and the coupling positioner 30a is formed on the blade 30 for easy assembly.

The assembly guide 43a formed on the guiding member 43 for centering the rubber blade 30, may be a centering hole 43b for securing the wiper 30; and the coupling positioner 30 may be a centering knob 30b formed at the center of the blade 30 for inserting into the centering hole 43b of the assembly guide 43a of the guiding member 43, in order to easily assemble the blade 30.

Thus, the wiper of the present invention includes a frame formed in one piece for supporting a blade that closely contacts a surface of an automotive windshield and being attached to a wiper arm for pressing and operating the wiper against and across the windshield via an adapter, so that the required number of parts is reduced and the wiper is unaffected by ice formation during the winter. Assembly of the blade to the tensile member is easy, and the latter evenly distributes load across the wiper to prevent streaking and judder of the wiper over the windshield. There is also no deformation of the wiper incurred by welding or assembly, and the wiper is strengthened while attaining an improved appearance and productibility. Interchangeability, ease of replacement, quality control, and freedom of design are increased, while it is financially viable to ship a larger quantity of the wipers of the present invention.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An automotive wiper having a frame supporting a blade that closely contacts a surface of an automotive windshield, the frame being attached to a wiper arm for pressing and operating the wiper against and across the windshield, and a tension spring with a predetermined tension and attached along insertion grooves of the blade for evenly distributing load along the blade onto the windshield, wherein the automotive wiper comprises:
a tensile member symmetrically extending in one piece from a center in opposite directions, forming both a single-piece tension spring and a skeletal frame that attaches to the wiper arm;
a slot centrally cut along a length of the tensile member for guiding the insertion grooves of the blade to be inserted therein;
a blade mounting receptacle formed at a center of the slot and symmetrical on either side of the slot; and
a guiding member formed above the mounting receptacle for guiding a top portion of the blade that inserts along the slot for aligning, supporting, and positioning the blade.

2. The automotive wiper of claim 1, wherein the mounting receptacle formed in the tensile member is symmetrically recessed a predetermined width inward from a central portion of the slot.

3. The automotive wiper of claim 2, wherein the guiding member formed on the tensile member is protrudingly formed to envelope an outer portion of the blade in a housing arch.

4. The automotive wiper of claim 1, further comprising an adapter formed in one piece with the tensile member at a center thereof for attaching to the wiper arm.

5. An automotive wiper having a frame supporting a blade that closely contacts a surface of an automotive windshield, the frame being attached to a wiper arm for pressing and operating the wiper against and across the windshield, and a tension spring with a predetermined tension and attached along insertion grooves of the blade for evenly distributing load along the blade onto the windshield, wherein the automotive wiper comprises:
a tensile member symmetrically extending in one piece from a center in opposite directions, forming both a single-piece tension spring and a skeletal frame that attaches to the wiper arm;
a slot centrally cut along a length of the tensile member for inserting the insertion grooves of the blade therein;
a blade mounting receptacle formed at a center of the slot for inserting the blade for assembly of the blade;
a guiding member formed above the mounting receptacle for guiding a top portion of the blade that inserts along the slot for aligning, supporting, and positioning the blade;
an assembly guide formed on the guiding member for centering the blade for assembly; and
a coupling positioner centrally disposed on a surface of the blade for positioning the blade for assembly with respect to the assembly guide formed on the guiding member.

6. The automotive wiper of claim 5, wherein the mounting receptacle formed on the tensile member is centrally formed from the central portion of the slot.

7. The automotive wiper of claim 5, wherein the guiding member formed on the tensile member is protrudingly formed to envelope an outer portion of the blade in a housing arch.

8. The automotive wiper of claim 5, wherein the assembly guide is a centering hole for centering and mounting the wiper blade.

9. The automotive wiper of claim 5, wherein the coupling positioner is formed at a central portion of the blade for inserting into the assembly guide on the guiding member.

10. The automotive wiper of claim 5, wherein the mounting receptacle formed on the tensile member is centrally formed in a central portion of the slot.

11. The automotive wiper of claim 5, further comprising an adapter formed in one piece with the tensile member at a center thereof for attaching to the wiper arm.
